(19) United States
(12) Patent Application Publication
(10) Pub. No.: US 2025/0074162 A1
(43) Pub. Date: Mar. 6, 2025

(54) AIR REGISTERS INCLUDING FIXED BLADES AND A ROTARY SHUTTER

(71) Applicant: Toyoda Gosei Co., Ltd., Kiyosu-shi (JP)

(72) Inventor: Roy C. Thorsell, Troy, MI (US)

(73) Assignee: Toyoda Gosei Co., Ltd., Kiyosu-shi (JP)

(21) Appl. No.: 18/461,956

(22) Filed: Sep. 6, 2023

(51) Int. Cl. B60H 1/34

(52) U.S. Cl. CPC B60H 1/3421

(57) ABSTRACT

An air register including a blade member including a plurality of vertical blades and a side wall defining a rear opening, a shutter rotatably coupled to the blade member, the shutter including a shutter gear, and a shaft rotatably coupled to the blade member, the shaft including a shaft gear engaging the shutter gear. Rotation of the shaft in one of a rotation direction and a counter-rotation direction opposite the rotation direction results in rotation of the shutter in the other of the rotation direction and the counter-rotation direction.

### TECHNICAL FIELD

The present specification generally relates to air registers for vehicles and, more specifically, air registers having an adjustable shutter for directing airflow.

### BACKGROUND

Air registers in vehicles typically include a plurality of vertical vanes that are selectively adjustable to direct airflow in a plurality of directions in a width direction or lateral direction of the vehicle. For example, the vertical vanes may be oriented toward the left to direct airflow to the left and to the right to direct airflow to the right. However, this results in numerous moving components to facilitate each vertical vane being simultaneously rotated. Additionally, as air flows through the air register, some of the air may contact a side wall of the air register and be redirected out of the air register. This redirected air affects a flow direction of the remaining air flowing through the air register such that the cumulative angle at which the air flows through the air register is not aligned with the selected orientation of the vertical air blades. Rather, the air flows more toward a center of the air register rather than the selected direction.

Accordingly, a need exists for improved air registers that provides fewer moving parts and more accurate airflow through the air registers and, thus, a reduced risk of part failure, reduced manufacturing costs and, a greater range for which air may be directed out of the air registers.

### SUMMARY

In one embodiment, air register includes: a blade member including a plurality of vertical blades and a side wall defining a rear opening; a shutter rotatably coupled to the blade member, the shutter including a shutter gear; and a shaft rotatably coupled to the blade member, the shaft including a shaft gear engaging the shutter gear, wherein rotation of the shaft in one of a rotation direction and a counter-rotation direction opposite the rotation direction results in rotation of the shutter in the other of the rotation direction and the counter-rotation direction.

In another embodiment, a vehicle includes: a dashboard; and an air register provided within the dashboard, the air register including: a blade member including a plurality of vertical blades and a side wall defining a rear opening; a shutter rotatably coupled to the blade member, the shutter including a shutter gear; and a shaft rotatably coupled to the blade member, the shaft including a shaft gear engaging the shutter gear, wherein rotation of the shaft in one of a rotation direction and a counter-rotation direction opposite the rotation direction results in rotation of the shutter in the other of the rotation direction and the counter-rotation direction.

In yet another embodiment, a method of operating an air register including a blade member including a plurality of vertical blades and a side wall defining a rear opening, a shutter rotatably coupled to the blade member, and a shaft rotatably coupled to the blade member includes: engaging a shaft gear on the shaft with a shutter gear on the shutter; rotating the shaft in one of a rotation direction and a counter-rotation direction opposite the rotation direction; and rotating the shutter across the rear opening of the blade member in the other of the rotation direction and the counter-rotation direction in response to rotation of the shaft to direct air into the blade member and through the rear opening to flow between the plurality of vertical blades.

These and additional features provided by the embodiments described herein will be more fully understood in view of the following detailed description, in conjunction with the drawings.

### BRIEF DESCRIPTION OF THE DRAWINGS

The embodiments set forth in the drawings are illustrative and exemplary in nature and not intended to limit the subject matter defined by the claims. The following detailed description of the illustrative embodiments can be understood when read in conjunction with the following drawings, where like structure is indicated with like reference numerals and in which:

FIG. 1 schematically depicts a partial front view of an interior of a vehicle including a plurality of air registers, according to one or more embodiments shown and described herein;

FIG. 2 schematically depicts a perspective view of the air register, according to one or more embodiments shown and described herein;

FIG. 3 schematically depicts an exploded perspective view of the air register, according to one or more embodiments shown and described herein;

FIG. 4A schematically depicts a partial top view of the air register in a center state with a shutter in a center position, according to one or more embodiments shown and described herein;

FIG. 4B schematically depicts a partial top view of the air register in the center state with the shutter in the center position, according to one or more embodiments shown and described herein;

FIG. 5A schematically depicts a partial top view of the air register in a left-intermediate state with the shutter in an intermediate counter-rotation position, according to one or more embodiments shown and described herein;

FIG. 5B schematically depicts a partial top view of the air register in the left-intermediate state with the shutter in the intermediate counter-rotation position, according to one or more embodiments shown and described herein;

FIG. 6A schematically depicts a partial top view of the air register in a left-most state with the shutter in a complete counter-rotation position, according to one or more embodiments shown and described herein;

FIG. 6B schematically depicts a partial top view of the air register in the left-most state with the shutter in the complete counter-rotation position and the shaft in the complete rotation position, according to one or more embodiments shown and described herein;

FIG. 7A schematically depicts a partial top view of the air register in a right-intermediate state with the shutter in an intermediate rotation position, according to one or more embodiments shown and described herein;

FIG. 7B schematically depicts a partial top view of the air register in the right-intermediate state with the shutter in the intermediate rotation position, according to one or more embodiments shown and described herein;

FIG. 8A schematically depicts a partial top view of the air register in a right-most state with the shutter in a complete rotation position, according to one or more embodiments shown and described herein; and

FIG. 8B schematically depicts a partial top view of the air register in the right-most state with the shutter in the complete rotation position, according to one or more embodiments shown and described herein.

### DETAILED DESCRIPTION

Embodiments described herein are directed to air registers including a shutter rotatable behind and relative to a plurality of fixed vertical blades within a blade member to control an intended flow direction of air flowing through the blade member of the air register. The air register includes the blade member, the shutter rotatably coupled to the blade member, and a shaft rotatably coupled to the blade member. The blade member includes a plurality of vertical blades and a side wall defining a rear opening, the shutter includes a shutter gear, and the shaft includes a shaft gear engaging the shutter gear. Rotation of the shaft in either a rotation direction or a counter-rotation direction opposite the rotation direction results in rotation of the shutter in the other of the rotation direction and the counter-rotation direction.

Various embodiments of the air register and the operation of the air register are described in more detail herein. Whenever possible, the same reference numerals will be used throughout the drawings to refer to the same or like parts.

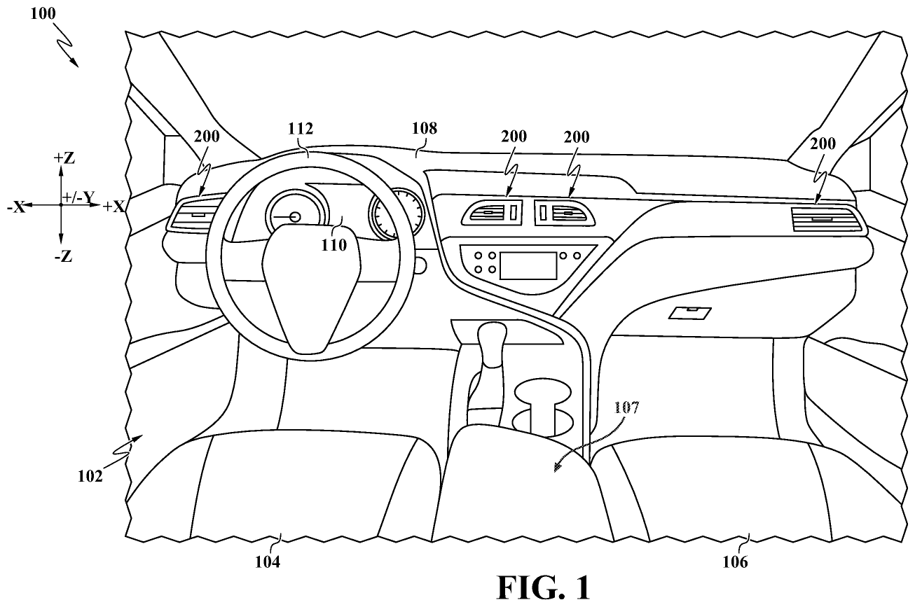

As used herein, the term “vehicle longitudinal direction” refers to the forward-rearward direction of the vehicle (i.e., in the +/−Y direction of the coordinate axes depicted in FIG. 1). The term “vehicle lateral direction” refers to the cross-vehicle direction (i.e., in the +/−X direction of the coordinate axes depicted in FIG. 1), and is transverse to the vehicle longitudinal direction. Specifically, “right” is defined as the positive X direction of the coordinate axes shown in the drawings, and “left” is defined as the negative X direction of the coordinate axes shown in the drawings. The term “vehicle vertical direction” refers to the upward-downward direction of the vehicle (i.e., in the +/−Z direction of the coordinate axes depicted in FIG. 1). As used herein, “upper” and “above” are defined as the positive Z direction of the coordinate axes shown in the drawings. “Lower” and “below” are defined as the negative Z direction of the coordinate axes shown in the drawings. As used herein, the term “rotation direction” refers to a clockwise rotation direction when viewed from a top plan view. Similarly, as used herein, the term “counter-rotation direction” refers to a counter-clockwise rotation direction when viewed from a top plan view.

Referring now to FIG. 1, a vehicle 100 is illustrated according to one or more embodiments described herein. The vehicle 100 includes an interior cabin 102 in which a driver seat 104 and a front passenger seat 106 are provided with a center console 107 provided therebetween. The vehicle 100 includes a dashboard 108 provided in front of the driver seat 104 and the front passenger seat 106. An instrument panel 110 is provided within the dashboard 108 and a steering wheel 112 is provided in front of the driver seat 104 extending in front of the instrument panel 110. As shown, the vehicle 100 includes a plurality of air registers 200 provided within the dashboard 108. However, it should be appreciated that the location of the air registers 200 is not limited to the specific location illustrated in FIG. 1. Rather, one or more air registers 200 may alternatively or additionally be provided at any other suitable location of the vehicle 100 such as, for example, in a rear passenger compartment of the vehicle 100 located behind the driver seat 104 and the front passenger seat 106, on a side door of the vehicle 100, on the rear of the center console 107, and the like.

As shown in FIG. 1, the vehicle 100 is provided as an automobile which includes coupes, sedans, minivans, trucks, crossovers, hybrids, and sports utility vehicles. However, the air register 200 is not limited to automobiles. In embodiments, the air register 200 may be provided in any vehicle such as a watercraft, aircraft, or the like.

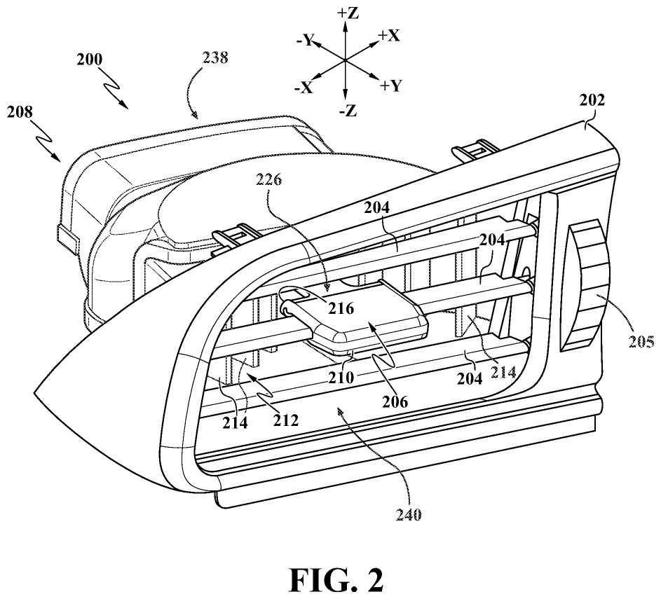

Referring now to FIG. 2, one of the air registers 200 of the vehicle 100 of FIG. 1 is shown separate from the vehicle 100. The air register 200 generally includes a frame 202, a plurality of horizontal fins 204 provided within the frame 202, a push knob 206 slidably mounted on one of the horizontal fins 204 within the frame 202, and a housing 208 provided rearwardly of the frame 202. In embodiments, the frame 202 may be fixed to the housing 208. In other embodiments, the frame 202 and the housing 208 may be individually fixed or coupled to the dashboard 108 of the vehicle 100 of FIG. 1.

Referring still to FIG. 2, the horizontal fins 204 are elongated planar members extending from opposite sides of a front opening 240 of the housing 208. The horizontal fins 204 control the flow of air flowing through the housing 208 in the vehicle vertical direction. The horizontal fins 204 are interconnected such that pivoting of one of the horizontal fins 204 results in pivoting of each of the horizontal fins 204. It should be appreciated that the horizontal fins 204 may be pivoted by operating the push knob 206 to orient a distal end 210 of the push knob 206 upward or downward in the vehicle vertical direction.

As described in more detail herein, the air register 200 further includes a blade member 212 provided within the housing 208. The blade member 212 includes a plurality of vertical blades 214 and a wheel 205. The wheel 205 is operably coupled to a vent door positionable between an open position and a closed position in any suitable manner including one or more linkages, gears, or the like. Although not shown, the vent door is located at a rear of the housing 208. When the wheel 205 is rotated in a first direction, the vent door is positioned into the open position such that air is permitted to flow into the housing 208 and through the blade member 212. When the wheel 205 is rotated in a second direction opposite the first direction, the vent door is positioned into the closed position such that air is prevented to flow into the housing 208 and through the blade member 212. It should be appreciated that the vent door is also positionable between any number of intermediate positions between the open position and the closed position by rotating the wheel 205 in the first direction or the second direction to control the amount of air that is permitted to flow through the housing 208 and the blade member 212.

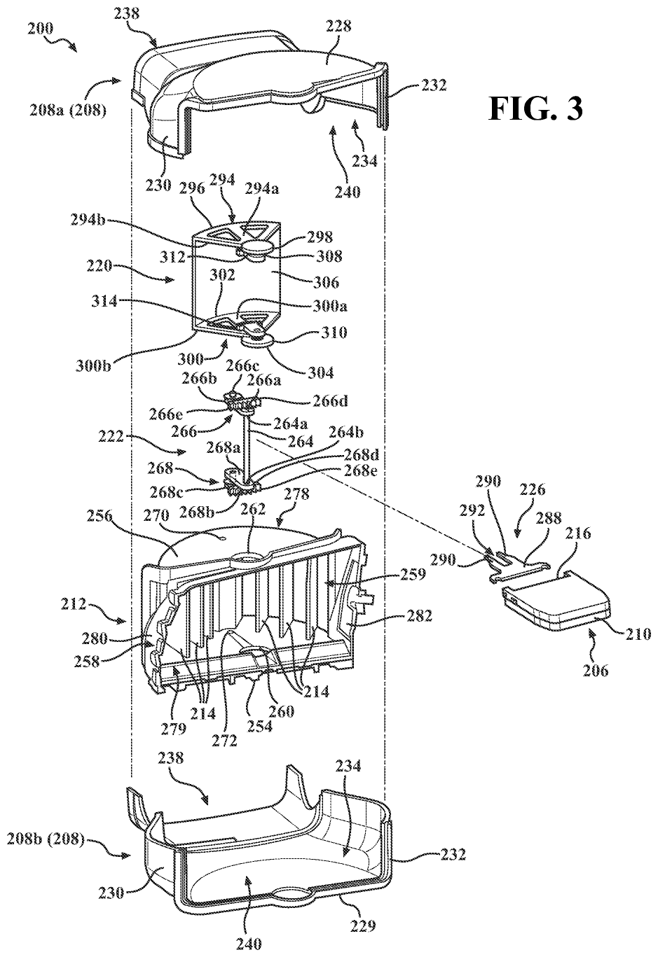

Referring now to FIG. 3, an exploded view of the air register 200 is illustrated. As shown, the air register 200 generally includes the housing 208, the blade member 212, and the push knob 206. The air register 200 further includes a shutter 220, a shaft 222, and a fork 226.

The housing 208, depicted as a two-part component, includes an upper wall 228, a lower wall 229, a side wall 230 extending between the upper wall 228 and the lower wall 229, and a front wall 232 formed along a perimeter of the upper wall 228, the lower wall 229, and the side wall 230. The upper wall 228, the lower wall 229, and the side wall 230 define an open interior 234 in which the blade member 212 and the shutter 220 are positioned. The blade member 212 may be fixed within the open interior 234 of the housing 208 in any suitable manner such as by, for example, fasteners, clips, brackets, and the like. A rear opening 238 is formed in the side wall 230 opposite the front wall 232. A front opening 240 is formed in the front wall 232 such that a flow path may be formed for air to flow through the housing 208, specifically, through the rear opening 238 into the housing 208 and through the front opening 240 out of the housing 208.

Although the housing 208 is depicted as including an upper housing portion 208a and a lower housing portion 208b, it should be appreciated that the housing 208 may be an integrally formed, one-piece component. If provided, the upper housing portion 208a and the lower housing portion 208b may be joined in any suitable manner such as by, for example, fasteners, clips, brackets, and the like.

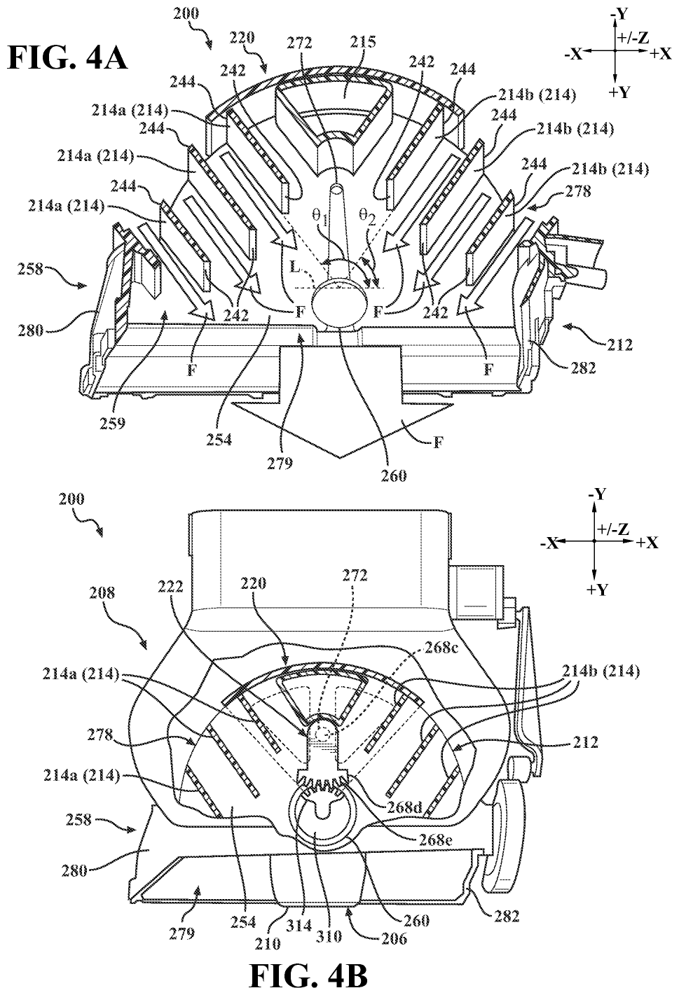

Referring to FIGS. 3 and 4A, the blade member 212 includes a bottom wall 254, a top wall 256 opposite the bottom wall 254, and a side wall 258 extending between the bottom wall 254 and the top wall 256, which cooperate to define an open interior 259 of the blade member 212. The vertical blades 214 extend between the bottom wall 254 and the top wall 256. In embodiments, a bottom blade member aperture 260 is formed in the bottom wall 254, and a top blade member aperture 262 is formed in the top wall 256. Additionally, in embodiments, a top blade member hole 270 is formed in the top wall 256, and a bottom blade member hole 272 is formed in the bottom wall 254. The side wall 258 of the blade member 212 defines a rear opening 278 allowing air to enter the blade member 212 and pass between the vertical blades 214, and a front opening 279 through which air exits the blade member 212. Additionally, the side wall 258 defines a first side wall portion 280 provided on one side of the rear opening 278 and a second side wall portion 282 provided on an opposite side of the rear opening 278.

As shown in FIG. 4A, each vertical blade 214 has a front end 242 and a rear end 244 opposite the front end 242. The front end 242 of each vertical blade 214 is positioned within the open interior 259 of the blade member 212 and the rear end 244 of each vertical blade 214 is provided at the rear opening 278 of the blade member 212. The vertical blades 214 are oriented to extend toward a center of the blade member 212, e.g., the bottom blade member aperture 260 of the blade member 212. More particularly, the vertical blades 214 include a plurality of first vertical blades 214a and a plurality of second vertical blades 214b. Additionally, a wedge blade 215 is provided between an inner most first vertical blade 214a and an inner most second vertical blade 214b.

The first vertical blades 214a are located closer to the first side wall portion 280 than to the second side wall portion 282. The first vertical blades 214a extend parallel to one another and generally in toward the second side wall portion 282 in the vehicle rearward direction. The first vertical blades 214a are oriented to extend at a first angle θ1 relative to a lateral axis L extending in the vehicle lateral direction and parallel to the +/−X axis of the coordinate axes depicted in the figures. In embodiments, the first angle θ1 is greater than or equal to 110 degrees and less than or equal to 160 degrees. In embodiments, the first angle θ1 is greater than or equal to 120 degrees and less than or equal to 150 degrees. In embodiments, the first angle θ1 is 135 degrees +/−5%. In embodiments, the first angle θ1 is 135 degrees +/−10%. In embodiments, the first angle θ1 is 135 degrees +/−15%. In embodiments, the first angle θ1 is 135 degrees +/−20%. In other embodiments, the first vertical blades 214a may extend parallel to one another each at a perpendicular angle, i.e., 90 degrees, relative to the lateral axis L. Accordingly, in this embodiment, the first vertical blades 214a extend straight, i.e., parallel to the vehicle longitudinal direction.

Similarly, the second vertical blades 214b are located closer to the second side wall portion 282 than to the first side wall portion 280. The second vertical blades 214b extend parallel to one another and generally toward the first side wall portion 280 in the vehicle rearward direction and opposite the first vertical blades 214a. The second vertical blades 214b are oriented to extend at a second angle θ2 relative to the lateral axis L. It should be appreciated that the second angle θ2 is a complementary angle to the first angle θ1 at which the first vertical blades 214a extend. Stated another way, the sum of the first angle θ1 and the second angle θ2 equals 180 degrees. In embodiments, the second angle θ2 is greater than or equal to 20 degrees and less than or equal to 70 degrees. In embodiments, the second angle θ2 is greater than or equal to 30 degrees and less than or equal to 60 degrees. In embodiments, the second angle θ2 is 45 degrees +/−5%. In embodiments, the second angle θ2 is 45 degrees +/−10%. In embodiments, the second angle θ2 is 135 degrees +/−15%. In embodiments, the second angle θ2 is 45 degrees +/−20%. In other embodiments, the second vertical blades 214b may extend parallel to one another each at a perpendicular angle, i.e., 90 degrees, relative to the lateral axis L. Accordingly, in this embodiment, the second vertical blades 214b extend straight, i.e., parallel to the vehicle longitudinal direction.

Although the blade member 212 is illustrated as including a total of six vertical blades 214, such as three first vertical blades 214a and three second vertical blades 214b, it should be appreciated that the blade member 212 may include any number of first vertical blades 214a and second vertical blades 214b such as, for example, two, four, or more than four. Additionally, the number of first vertical blades 214a does not need to be the same as the number of second vertical blades 214b.

Referring again to FIG. 3, the shaft 222 includes a shaft body 264 having an upper end 264a and a lower end 264b opposite the upper end 264a, an upper arm 266 provided at the upper end 264a, and a lower arm 268 provided at the lower end 264b. The upper arm 266 has an upper surface 266a and a lower surface 266b opposite the upper surface 266a, and the lower arm 268 has an upper surface 268a and a lower surface 268b opposite the upper surface 268a. In embodiments, the shaft 222 includes an upper shaft pin 266c extending from the upper surface 266a of the upper arm 266 in a direction opposite the lower arm 268, and a lower shaft pin 268c extending from the lower surface 268b of the lower arm 268 in a direction opposite the upper arm 266. However, it should be appreciated that the shaft 222 may include only one of the upper shaft pin 266c and the lower shaft pin 268c. In embodiments in which the shaft 222 includes the upper shaft pin 266c, the upper shaft pin 266c is received within the top blade member hole 270 formed in the top wall 256 of the blade member 212 when the shaft 222 is positioned within the blade member 212. Similarly, in embodiments in which the shaft 222 includes the lower shaft pin 268c, the lower shaft pin 268c is received within the bottom blade member hole 272 when the shaft 222 is positioned within the blade member 212. Additionally, in embodiments, the shaft 222 includes an upper shaft gear 266d formed on the upper surface 266a of the upper arm 266 of the shaft 222 adjacent the upper shaft pin 266c, and a lower shaft gear 268d formed on the lower surface 268b of the lower arm 268 of the shaft 222 adjacent the lower shaft pin 268c. However, it should be appreciated that the shaft 222 may include only one of the upper shaft gear 266d and the lower shaft gear 268d. The upper shaft gear 266d and the lower shaft gear 268d each include a plurality of teeth 266e, 268e extending radially in a direction opposite a respective one of the upper shaft pin 266c and the lower shaft pin 268c, if provided.

Referring still to FIG. 3, the fork 226 includes a fork body 288 and a pair of fingers 290 extending from the fork body 288. A gap 292 is formed between the pair of fingers 290 for engaging the shaft body 264 of the shaft 222. The fork 226 is insertable into a proximal end 216 of the push knob 206 opposite the distal end 210 to engage the push knob 206 and rotatably couple the push knob 206 to the shaft 222. The proximal end 216 of the push knob 206 is located forward of the distal end 210 of the push knob 206 in the vehicle longitudinal direction.

The shutter 220 includes an upper arm 294 having a first end 296, a second end 298 opposite the first end 296, an upper surface 294a, and a lower surface 294b opposite the upper surface 294a, a lower arm 300 having a first end 302, a second end 304 opposite the first end 302, an upper surface 300a, and a lower surface 300b opposite the upper surface 300a, and a blocking wall 306 extending between the second end 298 of the upper arm 294 and the second end 304 of the lower arm 300. In embodiments, an upper shutter boss 308 is formed on the lower surface 294b of the upper arm 294 proximate the second end 298 of the upper arm 294, and a lower shutter boss 310 is formed on the upper surface 300a of the lower arm 300 proximate the second end 304 of the lower arm 300. It should be appreciated that the shutter 220 may include only one of the upper shutter boss 308 and the lower shutter boss 310. Further, in embodiments, an upper shutter gear 312 is provided on the upper shutter boss 308 and a lower shutter gear 314 is provided on the lower shutter boss 310. When provided, the upper shutter boss 308 is received within the top blade member aperture 262 of the blade member 212, and the lower shutter boss 310 is received within the bottom blade member aperture 260 of the blade member 212. Thus, the shutter 220 is rotatably attached to the blade member 212. Additionally, as described in more detail herein, the upper shutter gear 312 engages the upper shaft gear 266d, and the lower shutter gear 314 engages the lower shaft gear 268d.

Referring now to FIGS. 4A and 4B, a partial view of the air register 200 is shown in a center state with the shutter 220 in a center position. Specifically, as shown in FIG. 4A, air is depicted by arrows F as flowing through the rear opening 278 formed in the blade member 212, between the vertical blades 214 of the blade member 212, and out of the blade member 212 through the front opening 279 of the blade member 212. In the center state, the push knob 206 is located at a center position in the vehicle lateral direction relative to the blade member 212 to orient the shutter 220 in the center position such that the blocking wall 306 is positioned to evenly overlap the first vertical blades 214a and the second vertical blades 214b. With the shutter 220 in the center position, air is evenly distributed to flow into the blade member 212 through the first vertical blades 214a and the second vertical blades 214b. Accordingly, the air flowing through the first vertical blades 214a contacts the air flowing through the second vertical blades 214b within the blade member 212 and is redirected through the front opening 279 of the blade member 212 to flow in a substantially vehicle longitudinal direction as opposed to being directed more toward either one of the first side wall portion 280 or the second side wall portion 282 of the blade member 212.

As shown in FIG. 4B, a top view of the air register 200 in the center state is depicted with components of the shutter 220 hidden by the bottom wall 254 of the blade member 212 shown in phantom. Specifically, in the center state, the lower shaft gear 268d of the shaft 222 is oriented to directly face and engage the lower shutter gear 314 of the shutter 220. As described in detail herein, movement of the push knob 206 in the vehicle lateral direction results in rotation of the shaft 222 about the lower shaft pin 268c, and/or the upper shaft pin 266c (FIG. 3). Due to the engagement of the teeth 268e of the lower shaft gear 268d with the lower shutter gear 314, rotation of the shaft 222 results in a corresponding rotation of the shutter 220 in an opposite direction.

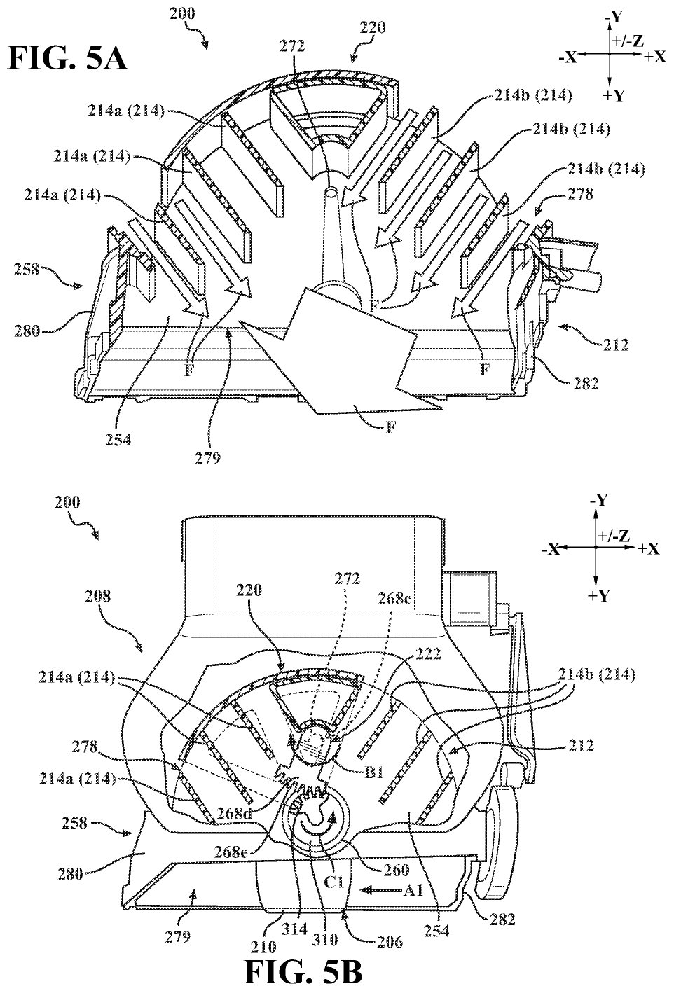

Referring now to FIGS. 5A and 5B, a partial view of the air register 200 is shown in a left-intermediate state with the shutter 220 in an intermediate counter-rotation position. Specifically, as shown in FIG. 5A, air is depicted by arrows F as flowing through the rear opening 278 formed in the blade member 212, between the vertical blades 214 of the blade member 212, and out of the blade member 212 through the front opening 279 of the blade member 212. In the left-intermediate state, the push knob 206 is moved in a first direction A1 in the vehicle lateral direction relative to the blade member 212 to rotate the shutter 220 in a counter-rotation direction C1 and into the intermediate counter-rotation position. With the shutter 220 in the intermediate counter-rotation position, the blocking wall 306 overlaps a larger portion of the first vertical blades 214a than a portion of the second vertical blades 214b overlapped by the blocking wall 306. With the shutter 220 in the intermediate counter-rotation position, more air is permitted to flow into the blade member 212 through the second vertical blades 214b than through the first vertical blades 214a. Accordingly, the additional air flowing through the second vertical blades 214b contacts the reduced air flowing through the first vertical blades 214a within the blade member 212 such that the air flows out of the blade member 212 in a direction closer to the first side wall portion 280 of the blade member 212 than the second side wall portion 282 of the blade member 212.

As shown in FIG. 5B, a top view of the air register 200 in the left-intermediate state is depicted with components of the shutter 220 hidden by the bottom wall 254 of the blade member 212 shown in phantom. As such, FIG. 5B indicates a position of the shutter 220 in the intermediate counter-rotation position when the air register 200 is in the left-intermediate state. Specifically, in the left-intermediate state, the push knob 206 is moved in the first direction A1 to rotate the shaft 222 in a rotation direction B1 about the lower shaft pin 268c, and/or the upper shaft pin 266c (FIG. 3). Due to the engagement of the teeth 268e of the lower shaft gear 268d of the shaft 222 with the lower shutter gear 314 of the shutter 220, rotation of the shaft 222 in the rotation direction B1 results in rotation of the shutter 220 in the counter-rotation direction C1 to position the shutter 220 in the intermediate counter-rotation position.

It should be appreciated that the shutter 220 is positionable into a plurality of intermediate counter-rotation positions to position the air register 200 in a plurality of left-intermediate states based on an amount of rotation of the shutter 220, which is dependent on an amount of translation of the push knob 206 in the first direction A1.

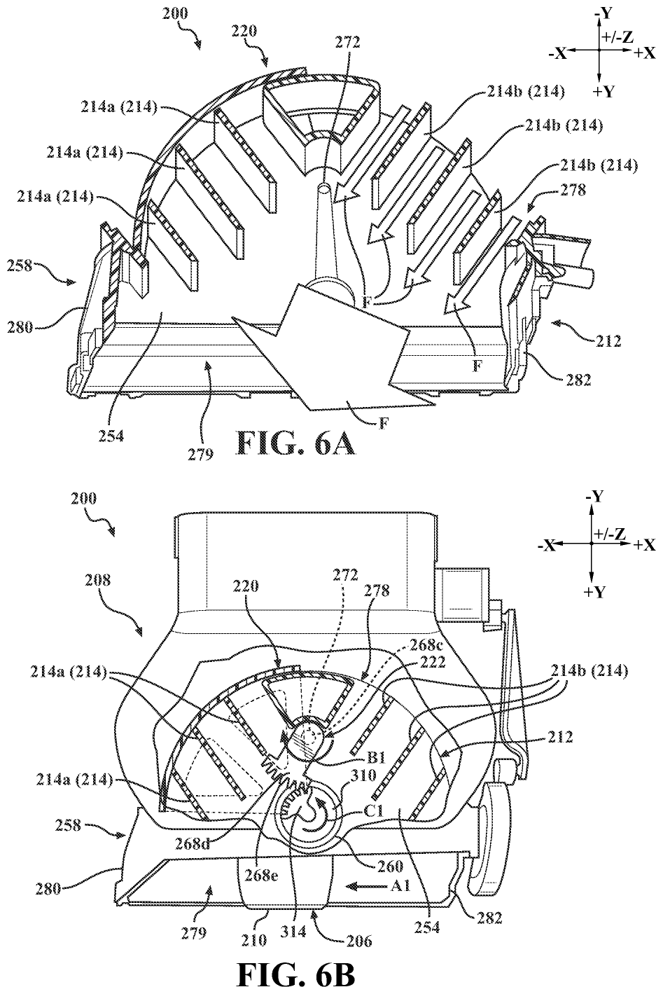

Referring now to FIGS. 6A and 6B, a partial view of the air register 200 is shown in a left-most state with the shutter 220 in a complete counter-rotation position. Specifically, as shown in FIG. 6A, air is depicted by arrows F as flowing through the rear opening 278 formed in the blade member 212, between the vertical blades 214 of the blade member 212, and out of the blade member 212 through the front opening 279 of the blade member 212. In the left-most state, the push knob 206 is moved further in the first direction A1 in the vehicle lateral direction relative to the blade member 212 to further rotate the shutter 220 in the counter-rotation direction C1 and into the complete counter-rotation position. With the shutter 220 in the complete counter-rotation position, the blocking wall 306 abuts against the first side wall portion 280 of the blade member 212. Additionally, the blocking wall 306 completely overlaps the first vertical blades 214a and does not overlap any portion of the second vertical blades 214b. With the shutter 220 in the complete counter-rotation position, air is permitted to flow into the blade member 212 through the second vertical blades 214b and prohibited from flowing through the first vertical blades 214a. Accordingly, the air flowing through the second vertical blades 214b is not impeded by air flowing through the first vertical blades 214a and thus flows out of the blade member 212 in a direction closer to the first side wall portion 280 of the blade member 212 than the second side wall portion 282 of the blade member 212, as compared the direction of air flowing through the blade member 212 when the air register 200 is in the left-intermediate state.

As shown in FIG. 6B, a top view of the air register 200 in the left-most state is depicted with components of the shutter 220 hidden by the bottom wall 254 of the blade member 212 shown in phantom. As such, FIG. 6B indicates a position of the shutter 220 in the complete counter-rotation position when the air register 200 is in the left-most state. Specifically, in the left-most state, the push knob 206 is moved further in the first direction A1 to continue to rotate the shaft 222 in the rotation direction B1 about the lower shaft pin 268c, and/or the upper shaft pin 266c (FIG. 3). As described herein, due to the engagement of the teeth 268e of the lower shaft gear 268d of the shaft 222 with the lower shutter gear 314 of the shutter 220, continued rotation of the shaft 222 in the rotation direction B1 results in rotation of the shutter 220 in the counter-rotation direction C1 to position the shutter 220 in the complete counter-rotation position.

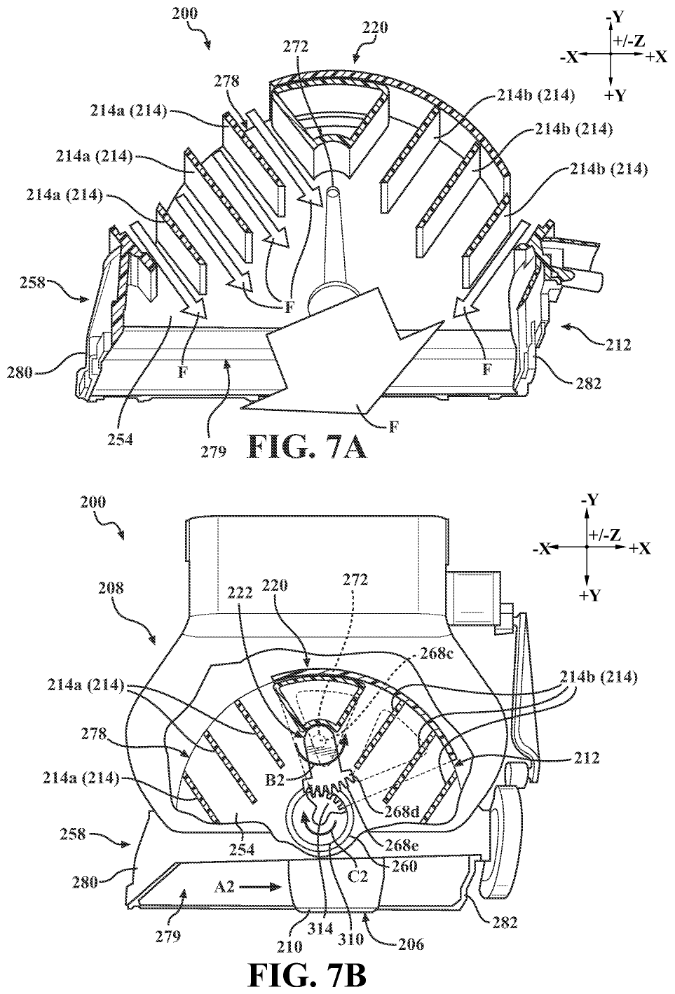

Referring now to FIGS. 7A and 7B, a partial view of the air register 200 is shown in a right-intermediate state with the shutter 220 in an intermediate rotation position. Specifically, as shown in FIG. 7A, air is depicted by arrows F as flowing through the rear opening 278 formed in the blade member 212, between the vertical blades 214 of the blade member 212, and out of the blade member 212 through the front opening 279 of the blade member 212. In the right-intermediate state, the push knob 206 is moved in a second direction A2 in the vehicle lateral direction opposite the first direction A1 (FIG. 5B) relative to the blade member 212 to rotate the shutter 220 in a rotation direction C2 and into the intermediate rotation position. With the shutter 220 in the intermediate rotation position, the blocking wall 306 overlaps a larger portion of the second vertical blades 214b than a portion of the first vertical blades 214a overlapped by the blocking wall 306. With the shutter 220 in the intermediate rotation position, more air is permitted to flow into the blade member 212 through the first vertical blades 214a than through the second vertical blades 214b. Accordingly, the additional air flowing through the first vertical blades 214a contacts the reduced air flowing through the second vertical blades 214b within the blade member 212 such that the air flows out of the blade member 212 in a direction closer to the second side wall portion 282 of the blade member 212 than the first side wall portion 280 of the blade member 212.

As shown in FIG. 7B, a top view of the air register 200 in the right-intermediate state is depicted with components of the shutter 220 hidden by the bottom wall 254 of the blade member 212 shown in phantom. As such, FIG. 7B indicates a position of the shutter 220 in the intermediate rotation position when the air register 200 is in the right-intermediate state. Specifically, in the right-intermediate state, the push knob 206 is moved in the second direction A2 to rotate the shaft 222 in a counter-rotation direction B2 opposite the rotation direction B1 (FIG. 5B) about the lower shaft pin 268c, and/or the upper shaft pin 266c (FIG. 3). Due to the engagement of the teeth 268e of the lower shaft gear 268d of the shaft 222 with the lower shutter gear 314 of the shutter 220, rotation of the shaft 222 in the counter-rotation direction B2 results in rotation of the shutter 220 in a rotation direction C2 opposite the counter-rotation direction C1 (FIG. 5B) to position the shutter 220 in the intermediate rotation position.

It should be appreciated that the shutter 220 is positionable into a plurality of intermediate rotation positions to position the air register 200 in a plurality of right-intermediate states based on an amount of rotation of the shutter 220, which is dependent on an amount of translation of the push knob 206 in the second direction A2.

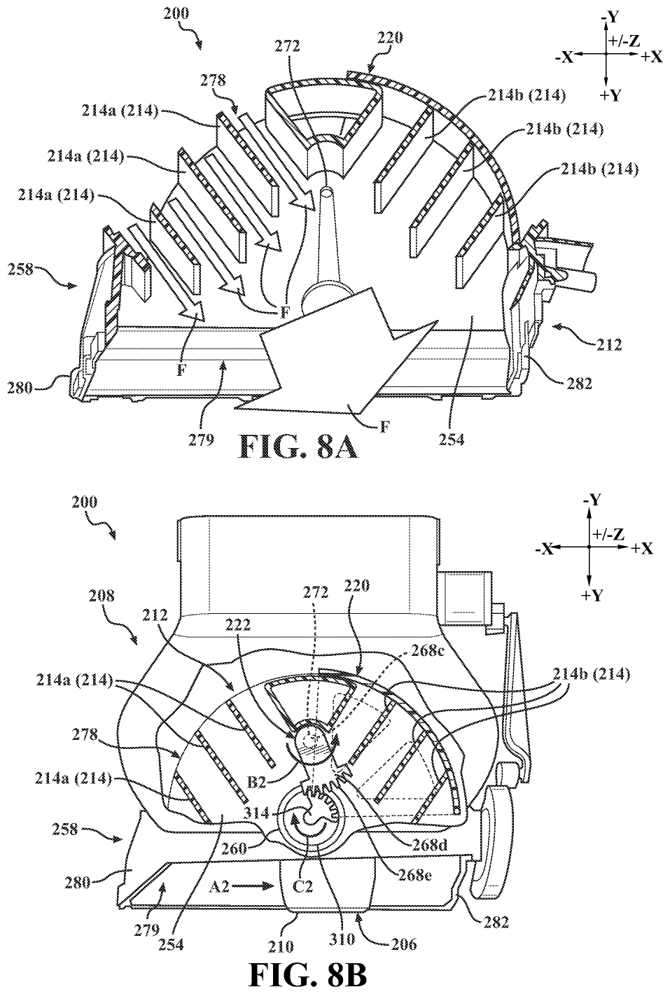

Referring now to FIGS. 8A and 8B, a partial view of the air register 200 is shown in a right-most state with the shutter 220 in a complete rotation position. Specifically, as shown in FIG. 8A, air is depicted by arrows F as flowing through the rear opening 278 formed in the blade member 212, between the vertical blades 214 of the blade member 212, and out of the blade member 212 through the front opening 279 of the blade member 212. In the right-most state, the push knob 206 is moved further in the second direction A2 in the vehicle lateral direction relative to the blade member 212 to further rotate the shutter 220 in the rotation direction C2 and into the complete rotation position. With the shutter 220 in the complete rotation position, the blocking wall 306 abuts against the second side wall portion 282 of the blade member 212. Additionally, the blocking wall 306 completely overlaps the second vertical blades 214b and does not overlap any portion of the first vertical blades 214a. With the shutter 220 in the complete rotation position, air is permitted to flow into the blade member 212 through the first vertical blades 214a and prohibited from flowing through the second vertical blades 214b. Accordingly, the air flowing through the first vertical blades 214a is not impeded by air flowing through the second vertical blades 214b and thus flows out of the blade member 212 in a direction closer to the second side wall portion 282 of the blade member 212 than the first side wall portion 280 of the blade member 212, as compared the direction of air flowing through the blade member 212 when the air register 200 is in the right-intermediate state.

As shown in FIG. 8B, a top view of the air register 200 in the right-most state is depicted with components of the shutter 220 hidden by the bottom wall 254 of the blade member 212 shown in phantom. As such, FIG. 8B indicates a position of the shutter 220 in the complete rotation position when the air register 200 is in the right-most state. Specifically, in the right-most state, the push knob 206 is moved further in the second direction A2 to continue to rotate the shaft 222 in the counter-rotation direction B2 about the lower shaft pin 268c, and/or the upper shaft pin 266c (FIG. 3). As described herein, due to the engagement of the teeth 268e of the lower shaft gear 268d of the shaft 222 with the lower shutter gear 314 of the shutter 220, continued rotation of the shaft 222 in the counter-rotation direction B2 results in rotation of the shutter 220 in the rotation direction C2 to position the shutter 220 in the complete rotation position.

Operation of the air register 200 is described herein as moving from the center state to the left-most state by translating the push knob 206 in the first direction A1, or moving from the center state to the right-most state by translating the push knob 206 in the second direction A2. However, it should be appreciated that operation of the air register 200 returning to the center state from either the left-most state or the right-most state is achieved by moving the push knob 206 in an opposite direction, which results in the above described movements of the individual components moving in a reverse direction.

From the above, it is to be appreciated that defined herein is an air register including a shutter rotatable behind and relative to a plurality of fixed vertical blades within a blade member to control an intended flow direction of air flowing through the air register. The air register includes a blade member, a shutter rotatably coupled to the blade member, and a shaft rotatably coupled to the blade member. The blade member includes a plurality of vertical blades and a side wall defining a rear opening, the shutter includes a shutter gear, and the shaft includes a shaft gear engaging the shutter gear. In embodiments, the vertical blades may be oriented at an angle toward a center of the blade member or, in other embodiments, straight or parallel to one another and the vehicle longitudinal direction. Rotation of the shaft in either a rotation direction or a counter-rotation direction opposite the rotation direction results in rotation of the shutter in the other of the rotation direction and the counter-rotation direction.

It is noted that the terms “substantially” and “about” may be utilized herein to represent the inherent degree of uncertainty that may be attributed to any quantitative comparison, value, measurement, or other representation. These terms are also utilized herein to represent the degree by which a quantitative representation may vary from a stated reference without resulting in a change in the basic function of the subject matter at issue.

While particular embodiments have been illustrated and described herein, it should be understood that various other changes and modifications may be made without departing from the scope of the claimed subject matter. Moreover, although various aspects of the claimed subject matter have been described herein, such aspects need not be utilized in combination. It is therefore intended that the appended claims cover all such changes and modifications that are within the scope of the claimed subject matter.

What is claimed is:

1. An air register comprising:
a blade member including a plurality of vertical blades and a side wall defining a rear opening;
a shutter rotatably coupled to the blade member, the shutter including a shutter gear; and
a shaft rotatably coupled to the blade member, the shaft including a shaft gear engaging the shutter gear,
wherein rotation of the shaft in one of a rotation direction and a counter-rotation direction opposite the rotation direction results in rotation of the shutter in the other of the rotation direction and the counter-rotation direction.

2. The air register of claim 1, further comprising a housing defining an open interior, the blade member provided within the open interior of the housing.

3. The air register of claim 1, wherein the plurality of vertical blades comprises a plurality of first vertical blades extending parallel to one another and in a first direction toward a center of the blade member, and a plurality of second vertical blades extending parallel to one another and in a second direction opposite the first direction toward the center of the blade member.

4. The air register of claim 1, further comprising:
a horizontal fin;
a push knob slidably engaging the horizontal fin; and
a fork rotatably coupling the push knob to the shaft and movable in a vehicle vertical direction.

5. The air register of claim 4, wherein:
movement of the push knob in a first direction results in the shaft rotating in the rotation direction and the shutter rotating in the counter-rotation direction; and
movement of the push knob in a second direction opposite the first direction results in the shaft rotating in the counter-rotation direction and the shutter rotating in the rotation direction.

6. The air register of claim 1, wherein the shutter includes an upper arm, a lower arm opposite the upper arm, and a blocking wall extending between the upper arm and the lower arm, and the blocking wall overlaps the rear opening formed in the blade member.

7. The air register of claim 6, wherein the shutter includes a shutter boss formed at one of the upper arm and the lower arm of the shutter and is received within a blade member aperture formed in one of a top wall and a bottom wall of the blade member to rotatably couple the shutter to the blade member.

8. The air register of claim 7, wherein the shutter boss is an upper shutter boss formed at the upper arm of the shutter and the blade member aperture is a top blade member aperture formed in the top wall of the blade member, the shutter gear is an upper shutter gear formed on the upper shutter boss.

9. The air register of claim 8, wherein the shaft includes an upper arm having an upper shaft pin engaging an upper blade member hole formed in the top wall of the blade member, and a lower arm opposite the upper arm having a lower shaft pin engaging a bottom blade member hole formed in the bottom wall of the blade member.

10. The air register of claim 9, wherein the shaft gear is an upper shaft gear formed on the upper arm of the shaft and engages the upper shutter gear of the shutter.

11. The air register of claim 10, wherein the shutter includes a lower shutter boss formed at the lower arm of the shutter and is received within a bottom blade member aperture formed the bottom wall of the blade member.

12. The air register of claim 11, wherein the shutter includes a lower shutter gear formed on the lower shutter boss, and the shaft includes a lower shaft gear formed on the lower arm of the shaft, the lower shutter gear of the shutter engages the lower shaft gear of the shaft.

13. A vehicle comprising:
a dashboard; and
an air register provided within the dashboard, the air register comprising:
a blade member including a plurality of vertical blades and a side wall defining a rear opening;
a shutter rotatably coupled to the blade member, the shutter including a shutter gear; and
a shaft rotatably coupled to the blade member, the shaft including a shaft gear engaging the shutter gear,
wherein rotation of the shaft in one of a rotation direction and a counter-rotation direction opposite the rotation direction results in rotation of the shutter in the other of the rotation direction and the counter-rotation direction.

14. The air register of claim 13, further comprising:
a horizontal fin;
a push knob slidably engaging the horizontal fin; and
a fork rotatably coupling the push knob to the shaft,
wherein movement of the push knob in a first direction results in the shaft rotating in the rotation direction and the shutter rotating in the counter-rotation direction,
wherein movement of the push knob in a second direction opposite the first direction results in the shaft rotating in the counter-rotation direction and the shutter rotating in the rotation direction.

15. The air register of claim 13, wherein the shutter includes an upper arm, a lower arm opposite the upper arm, and a blocking wall extending between the upper arm and the lower arm, and the blocking wall overlaps the rear opening formed in the blade member.

16. The air register of claim 15, wherein the shutter includes a shutter boss formed at one of the upper arm and the lower arm of the shutter and is received within a blade member aperture formed in one of a top wall and a bottom wall of the blade member to rotatably couple the shutter to the blade member, the shutter gear is formed on the shutter boss.

17. The air register of claim 16, wherein the shaft includes an upper arm and a lower arm opposite the upper arm, a shaft pin is provided on one of the upper arm and the lower arm and is received within a blade member hole formed in one of the top wall and the bottom wall of the blade member.

18. A method of operating an air register comprising a blade member including a plurality of vertical blades and a side wall defining a rear opening, a shutter rotatably coupled to the blade member, and a shaft rotatably coupled to the blade member, the method comprising:
engaging a shaft gear on the shaft with a shutter gear on the shutter;
rotating the shaft in one of a rotation direction and a counter-rotation direction opposite the rotation direction; and
rotating the shutter across the rear opening of the blade member in the other of the rotation direction and the counter-rotation direction in response to rotation of the shaft to direct air into the blade member and through the rear opening to flow between the plurality of vertical blades.

19. The method of claim 18, further comprising:
translating a push knob along a horizontal fin in one of a first direction and a second direction opposite the first direction, the push knob coupled to a fork, the fork rotatably coupled to the shaft;
rotating the shaft in the rotation direction and the shutter in the counter-rotation direction in response to translating the push knob in the first direction; and
rotating the shaft in the counter-rotation direction and the shutter in the rotation direction in response to translating the push knob in the second direction.

20. The method of claim 19, wherein the plurality of vertical blades comprises a plurality of first vertical blades extending parallel to one another and in a first direction toward a center of the blade member, and a plurality of second vertical blades extending parallel to one another and in a second direction opposite the first direction toward the center of the blade member.
